(19) United States
(12) Patent Application Publication
(10) Pub. No.: US 2021/0319298 A1
(43) Pub. Date: Oct. 14, 2021

(54) COMPUTE-BASED SUBGRAPH PARTITIONING OF DEEP LEARNING MODELS FOR FRAMEWORK INTEGRATION

(71) Applicant: Intel Corporation, Santa Clara, CA (US)

(72) Inventors: Surya Siddharth Pemmaraju, Santa Clara, CA (US); Yamini Nimmagadda, Portland, OR (US); Srinivasa Manohar Karlapalem, Santa Clara, CA (US)

(21) Appl. No.: 17/357,340

(22) Filed: Jun. 24, 2021

(51) Int. Cl. G06N 3/063; G06N 3/04

(52) U.S. Cl. CPC G06N 3/063; G06N 3/04

(57) ABSTRACT

Systems, apparatuses and methods provide technology for efficient subgraph partitioning, including generating a first set of subgraphs based on supported nodes of a model graph, wherein the supported nodes have operators that are supported by a hardware backend device, evaluating a compute efficiency of each subgraph of the first set of subgraphs with respect to the hardware backend device and to a default CPU associated with a default runtime, and selecting, from the first set of subgraphs, a second set of subgraphs to be run on the hardware backend device based on the evaluated compute efficiency. The technology can include calculating a backend performance factor for each subgraph for the hardware backend device, calculating a default performance factor for each subgraph for the default CPU, and comparing, for each respective subgraph of the of the first set of subgraphs, the backend performance factor and the default performance factor.

### TECHNICAL FIELD

Embodiments generally relate to computing systems. More particularly, embodiments relate to framework integration for deep learning systems.

### BACKGROUND

Many of the popular deep learning frameworks such as TENSORFLOW, PYTORCH, ONNX RUNTIME, PADDLEPADDLE and others can work with different hardware (HW) acceleration libraries to execute the deep learning models on the hardware platform. Each framework may support an extensible interface that would help to integrate with the HW specific libraries. This interface enables flexibility for the application developers to deploy models in different environments in the cloud and the edge and optimize the execution of artificial intelligence (AI) models by taking advantage of the compute capabilities of the platform. These frameworks can work with the execution providers (EPs), which have the interface to allocate specific nodes or sub-graphs in an AI model for execution by the EP library in supported hardware. The EP libraries that are pre-installed in the execution environment process and execute the sub-graph of the model on the hardware. This architecture abstracts out the details of the hardware specific libraries that optimize the execution of deep neural networks across hardware platforms such as a central processing unit (CPU), graphics processing unit (GPU), field-programmable gate array (FPGA) or specialized application specific integrated circuit (ASIC).

A single framework today may be integrated with many other accelerated backend systems (“backends”) for faster inferencing. For example, the ONNX Runtime package from MICROSOFT can be built with any combination of the execution provider along with a default CPU execution provider. The TENSORRT execution provider in the ONNX Runtime makes use of the TENSORRT Deep Learning inferencing engine from NVIDIA to accelerate the ONNX model in a family of GPUs. Similarly, the OPENVINO execution provider enables deep learning inference on CPUs, integrated GPUs and Vision Processing Units (VPUs) from INTEL. Framework integration of backends enables unsupported operators or a cluster of operators to be run on default runtimes and the rest of the supported graph to be run on an accelerated backend to obtain the best performance of the overall model on targeted hardware. If some operators in the model are not supported by an accelerated backend, then the corresponding deep learning framework will partition the graph and only send supported subgraphs to the accelerated backend, with the unsupported subgraphs falling back to the default backend from the framework. Compute and memory requirements may often be estimated using heuristics, with clusters being executed either on the accelerated backend or the framework runtime.

### BRIEF DESCRIPTION OF THE DRAWINGS

The various advantages of the embodiments will become apparent to one skilled in the art by reading the following specification and appended claims, and by referencing the following drawings, in which:

FIG. 1 provides a block diagram illustrating an example AI framework integration system according to one or more embodiments;

FIG. 2A provides a diagram illustrating an example process flow for operating an AI framework integration system according to one or more embodiments;

FIG. 2B provides a diagram illustrating an example method of compute-based graph partitioning according to one or more embodiments;

FIG. 3A provides a flow chart illustrating an example method of operating an AI framework integration system according to one or more embodiments;

FIG. 3B provides a flow chart illustrating an example method for compute-based graph partitioning according to one or more embodiments;

FIG. 4 is a block diagram illustrating an example computing system for AI framework integration according to one or more embodiments;

FIG. 5 is a block diagram illustrating an example semiconductor apparatus according to one or more embodiments;

FIG. 6 is a block diagram illustrating an example processor according to one or more embodiments; and

FIG. 7 is a block diagram illustrating an example of a multiprocessor-based computing system according to one or more embodiments.

### DESCRIPTION OF EMBODIMENTS

An improved computing system as described herein provides technology for efficient subgraph partitioning that creates optimal subgraphs for running on backends that have performance advantages over a default runtime. The technology helps improve the overall performance of deep learning models by selectively providing for subgraphs to be run on a backend in a manner to reduce or eliminate unnecessary fallbacks between the default runtime and the backend. For example, non-optimal subgraph partitioning can create a lot of subgraphs that cause a high frequency of transition between supported and unsupported operators, resulting in excessive data transfer overhead and reduced performance—particularly when there are a lot of subgraphs with relatively low compute. This inefficiency can be exacerbated when using accelerators that do not have shared memory with the host, such that the intermediate output data transfer becomes a huge overhead and can result in lower performance than the default runtime.

The improved technology as described herein includes a subgraph partitioning algorithm that uses metrics such as compute in the model, intermediate output sizes and maximum compute capacity of the backend device. Given a deep learning model and a target backend device to be executed on, the technology creates subgraphs that are based on supported operators or nodes. Once the subgraphs are created, the technology evaluates which graphs are, or are not, compute efficient to run on the backend by checking if the data transfer overhead is more than the potential performance that can be achieved using the backend. Those subgraphs which can be efficiently run on the backend are selected for the backend inference, and those subgraphs which are not efficient for running on the backend are removed so that the nodes are run instead on the default runtime.

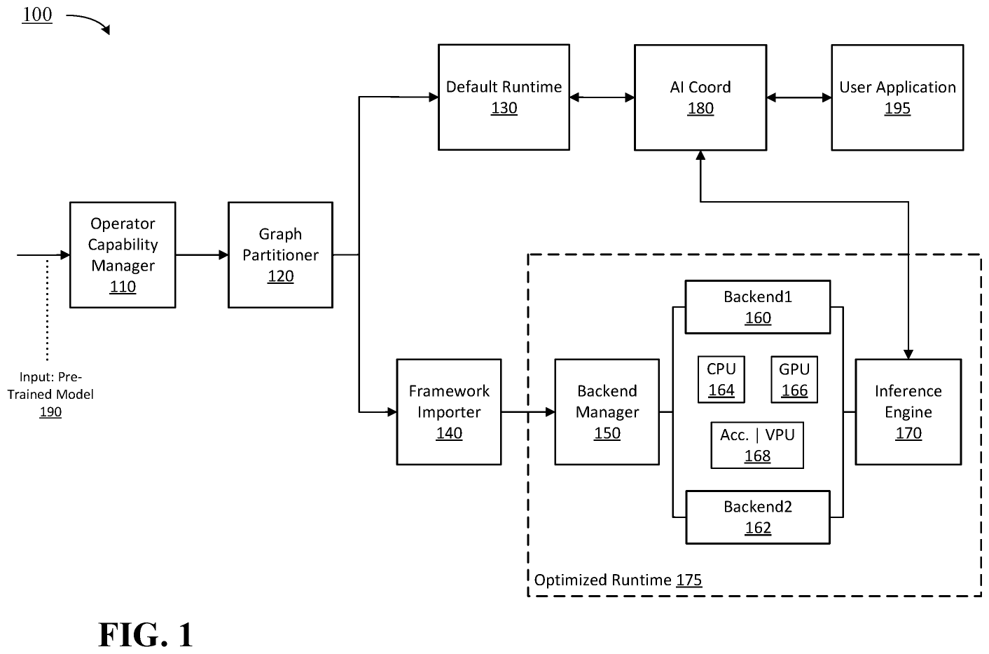

FIG. 1 provides a block diagram illustrating an example of an AI framework integration system 100 according to one or more embodiments, with reference to components and features described herein including but not limited to the figures and associated description. As shown in FIG. 1, the system 100 includes an operator capability manager 110, a graph partitioner 120, a default runtime 130, a framework importer 140, a backend manager 150, a first backend (backend1) 160, a second backend (backend2) 162, hardware execution units including a CPU 164, a GPU 166, and a hardware accelerator such as a vision processing unit (VPU) 168 (or another type of hardware AI accelerator), an inference engine 170 and an AI coordinator 180. It is understood that a variety of hardware execution units including a plurality of CPUs 164, GPUs 166 and/or VPUs 168 can be employed in the system 100. It is further understood that a variety of backends can be included in the system 100. Together, the backend manager 150, the first backend (backend1) 160, the second backend (backend2) 162, the hardware execution units (including one or more CPUs 164, one or more GPUs 166, and one or more VPUs 168) and the inference engine 170 form an optimized runtime 175.

The system 100 receives as input a pre-trained model 190. The pre-trained model 190 can be developed using an AI framework from a variety of sources, including, for example, TensorFlow, ONNX Runtime, PyTorch, etc. The pre-trained model 190 typically includes information and data regarding the model architecture (i.e., graph), including nodes, operators, weights and biases. Each node in a model graph represents an operation (e.g. mathematical, logical operator etc.) which is evaluated at runtime.

The operator capability manager 110 receives the input pre-trained model 190 and analyzes the operators in the model to determine which operators or nodes are supported, and under what conditions, by the available backend technology and hardware units. The analysis includes evaluating the operators, attributes, data types, and input nodes. The operator capability manager 110 marks the operators or nodes as supported or unsupported.

The graph partitioner 120 takes the pretrained model architecture, as marked by the operator capability manager 110, and partitions (e.g., divides) the model into subgraphs (i.e., groups of operators, or clusters). The subgraphs are allocated into two groups—supported subgraphs and unsupported subgraphs. Supported subgraphs are those subgraphs having operators or nodes that are supported by the available backend technology and hardware units under the conditions present in the model. Unsupported subgraphs are those subgraphs having operators or nodes that are not supported by the available backend technology and hardware units under the conditions present in the model. Supported subgraphs are designated for further processing to be run via the optimized runtime 175. Unsupported subgraphs are designated to be run via the default runtime 130. In some circumstances, the system can be “tuned” to enhance speed and efficiency in execution speed and/or memory usage by re-designating certain supported subgraphs to be executed via the default runtime.

The default runtime 130 is the basic runtime package provided for the AI framework corresponding to the input pre-trained model 190. The default runtime 130 executes on basic CPU hardware with no hardware accelerator support. The default runtime 130 typically includes a compiler to compile the unsupported subgraphs into executable code to be run on the basic CPU hardware.

The framework importer 140 receives supported subgraphs from the graph partitioner 120. The subgraphs are typically in a format specific to the framework used to generate the model. The framework importer 140 takes the subgraphs and generates an intermediate representation for these subgraphs, to be interpreted (i.e., read/parsed) by the optimized runtime 175. The intermediate representation produces a structured data set comprising the model architecture, metadata, weights and biases.

The backend manager 150 receives the intermediate representation of the supported model subgraphs and applies optimization techniques to optimize execution of the model using available backends and hardware options. For example, the backend manager 150 can select among available backends, e.g., the backend1 160 or the backend2 162. In some embodiments, the backend1 160 represents a basic backend that is optimized for a particular group of hardware units. For example, where the optimized runtime 175 utilizes the Open Visual Inference and Neural network Optimization (OpenVINO) runtime technology, the backend1 160 can be the OpenVINO backend. In some embodiments, the backend2 162 can be a backend such as VAD-M, which is optimized for machine vision tasks using a VPU such as the Intel® Myriad X VPU. The selected backend compiles (via a compiler) supported subgraphs into executable code, and performs optimization. The backend manager also selects among the available hardware units—the CPU 164, GPU 166 and/or VPU (or AI accelerator) 168. The backend manager 150 also dispatches data to the selected backend and schedules execution (inference) of the optimized model via the inference engine 170.

The inference engine 170 controls execution of the model code on the various hardware units that are employed for the particular model optimization. The inference engine 170 reads the input data and compiled graphs, instantiates inference on the selected hardware, and returns the output of the inference.

The AI coordinator 180 coordinates execution of AI workflow requests from a user application 195. The AI workflow requests are handled between the default runtime 130 (executing code generated from unsupported subgraphs) and the optimized runtime 175 (e.g., executing code generated from supported subgraphs). In one or more embodiments, the AI coordinator 180 is integrated within the default runtime 130. In one or more embodiments, the AI coordinator 180 is integrated within the optimized runtime 175.

Some or all components in the system 100 may be implemented using one or more of a CPU, a GPU, an AI accelerator, a FPGA accelerator, an ASIC, and/or via a processor with software, or in a combination of a processor with software and an FPGA or ASIC. More particularly, components of the system 100 may be implemented in one or more modules as a set of logic instructions stored in a machine- or computer-readable storage medium such as random access memory (RAM), read only memory (ROM), programmable ROM (PROM), firmware, flash memory, etc., in configurable logic such as, for example, programmable logic arrays (PLAs), FPGAs, complex programmable logic devices (CPLDs), in fixed-functionality logic hardware using circuit technology such as, for example, ASIC, complementary metal oxide semiconductor (CMOS) or transistor-transistor logic (TTL) technology, or any combination thereof.

For example, computer program code to carry out operations by the system 100 may be written in any combination of one or more programming languages, including an object oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Compute-Based Subgraph Partitioning

A deep learning model graph may contain many operators, some of which are supported by the backend and some of which are not supported by the backend. These operators can occur anywhere in the graph, and non-optimal subgraph partitioning of supported/unsupported nodes can result in inefficiencies and reduced performance. The compute-based subgraph partitioning technology described herein helps to reduce or eliminate inefficiencies such as excessive data transfer overhead caused by a high rate of transition between the backend and default runtime. The subgraph partitioning technology uses metrics such as the compute in the model (e.g., measured in FLOPS, TOPS, etc), intermediate output sizes and maximum compute capacity of the target backend device, along with a compute capacity of the default runtime CPU. Using these metrics, the technology can determine which subgraphs are more efficient to run on the target backend compared to the default runtime. For example, the technology can offload subgraphs which are not compute efficient to run on the backend by checking if the data transfer overhead is more than the potential performance that can be achieved using the backend.

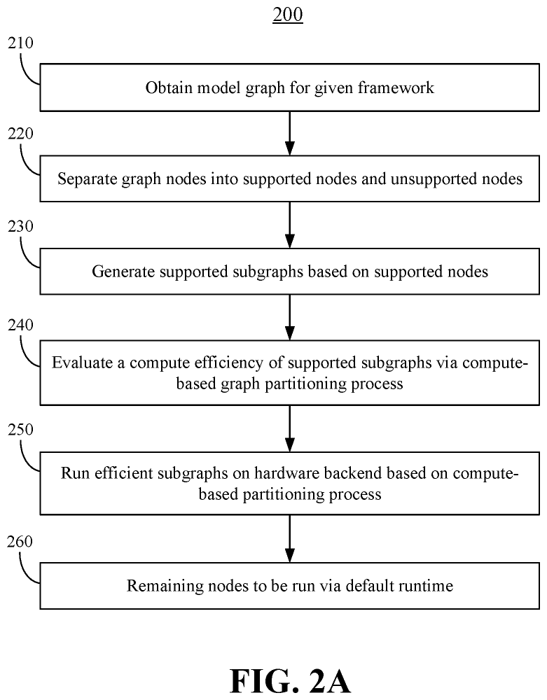

Turning now to FIG. 2A, a diagram is provided illustrating a process flow or method 200 for operating an AI framework integration system according to one or more embodiments, with reference to components and features described herein including but not limited to the figures and associated description. The method 200 can generally be implemented in the system 100 (FIG. 1, already discussed). More particularly, the method 200 can be implemented as one or more modules in a set of logic instructions stored in a non-transitory machine- or computer-readable storage medium such as RAM, ROM, PROM, firmware, flash memory, etc., in configurable logic such as, for example, PLAs, FPGAs, CPLDs, in fixed-functionality hardware logic using circuit technology such as, for example, ASIC, CMOS or TTL technology, or any combination thereof.

For example, computer program code to carry out operations shown in the method 200 can be written in any combination of one or more programming languages, including an object oriented programming language such as JAVA, SMALLTALK, C++ or the like and conventional procedural programming languages, such as the “C” programming language or similar programming languages. Additionally, logic instructions might include assembler instructions, ISA instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 210 provides for obtaining a model graph for a given framework. The model graph can be one developed using an AI framework, and typically includes information and data regarding the model architecture (i.e., graph), including nodes, operators, weights and biases. The model graph can correspond to the pre-trained model 190 (FIG. 1, already discussed).

Illustrated processing block 220 provides for separating model graph nodes into supported nodes and unsupported nodes. Supported nodes are those nodes with operators that are supported by the available or target backend technology and hardware units under the conditions present in the model. Unsupported nodes are those nodes with operators that are not supported by the available or target backend technology and hardware units under the conditions present in the model. The separation of the model graph into supported nodes and unsupported nodes can be implemented, e.g., by the operator capability manager 110 (FIG. 1, already discussed).

Illustrated processing block 230 provides for generating supported subgraphs based on supported nodes. Supported subgraphs are clusters of supported nodes. The generation of supported subgraphs can be implemented, e.g., by the graph partitioner 120 (FIG. 1, already discussed). In embodiments, unsupported subgraphs (i.e., clusters of unsupported nodes) will be created or handled by the default framework.

Illustrated processing block 240 provides for evaluating a compute efficiency of each subgraph of the supported subgraphs relative to the hardware backend device and to a default CPU associated with the default runtime, via a compute-based graph partitioning process. The compute-based graph partitioning process for the supported subgraphs can be implemented, e.g., by the graph partitioner 120 (FIG. 1, already discussed). The compute-based graph partitioning process evaluates, for each supported subgraph, a potential performance on the backend device using a set of metrics such as the compute in the model (e.g., number of operations measured in FLOPS, TOPS, etc), data transfer time, and maximum compute capacity of the target backend device. The compute-based graph partitioning process further evaluates, for each supported subgraph, a potential performance on the default runtime CPU using the compute in the model and a compute capacity of the default runtime CPU. By evaluating of these metrics for each supported subgraph, the technology can determine which subgraphs are more efficient to run on the target backend compared to the default runtime. In embodiments, the compute-based graph partitioning process evaluates these metrics, for each supported subgraph, using an algorithm (such as, e.g., via the method 270 described in FIG. 2B below).

Those supported subgraphs which can run more efficiently on the backend device than the default runtime CPU are selected to be run on the backend device (i.e., backend inference). Subgraphs for which the performance on the backend device is not better than the default runtime are not selected for backend inference. Instead, nodes for those unselected subgraphs can be run on the default runtime.

Illustrated processing block 250 provides for running the efficient subgraphs on the hardware backend, where the efficient subgraphs are as selected based on the compute-based graph partitioning process.

At illustrated processing block 260, the remaining nodes are to be run via the default runtime. The remaining nodes are the nodes from the supported subgraphs that are not selected to be run on the backend device, along with the unsupported nodes.

FIG. 2B provides a diagram illustrating an example method 270 of compute-based graph partitioning according to one or more embodiments, with reference to components and features described herein including but not limited to the figures and associated description. The method 270 is performed for each subgraph of the supported subgraphs, and can generally be substituted for all or a portion of illustrated processing block 240 (FIG. 2A, already discussed). More particularly, the method 270 can be implemented as one or more modules in a set of logic instructions stored in a non-transitory machine- or computer-readable storage medium such as RAM, ROM, PROM, firmware, flash memory, etc., in configurable logic such as, for example, PLAs, FPGAs, CPLDs, in fixed-functionality hardware logic using circuit technology such as, for example, ASIC, CMOS or TTL technology, or any combination thereof.

For example, computer program code to carry out operations shown in the method 270 can be written in any combination of one or more programming languages, including an object oriented programming language such as JAVA, SMALLTALK, C++ or the like and conventional procedural programming languages, such as the “C” programming language or similar programming languages. Additionally, logic instructions might include assembler instructions, ISA instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 271 provides for determining a software efficiency factor or metric (SW_Efficiency) for running the subgraph on the hardware backend device compared to the default runtime CPU. Software efficiency for a device is a measure or estimate of the efficiency of the software implementation when run on the device, which can be a CPU or a hardware accelerator (GPU, VPU etc). The software efficiency can be calculated or estimated for a device by running a micro benchmark analysis which can comprise of one or more unit tests, operator tests, or small model tests, etc. and compare the results of the benchmark with the theoretical max compute for the device. This software efficiency analysis can be performed for the hardware backend device under consideration, as well as for the default runtime CPU. The software efficiency factor or metric is determined based on a comparison (e.g., ratio) of the software efficiency for the hardware backend device under consideration to the software efficiency for the default runtime CPU.

Illustrated processing block 272 provides for determining a number of operations in the subgraph. In examples, the number of operations can be provided as the number of floating point operations (FLOP subgraph).

Illustrated processing block 273 provides for calculating a data transfer time (DTT) for the subgraph—i.e., if the subgraph would be run on the backend device. The data transfer time takes into consideration the data transfer between the between the hardware backend unit (e.g., accelerator) memory and host memory. Typically, hardware accelerator backends do not share memory with the host. Thus, whenever data needs to be transferred to the host, it needs to go through an interface (which can be PCIe, USB etc.). The data transfer time (DTT) can be determined by using the output dimensions of the subgraph in bytes (e.g., the number of bytes in an output tensor for an output node of the subgraph) and multiplying by the interface transfer rate (i.e., the data transfer rate between the backend and the default runtime). For example, for backend devices that are connected via a PCIe bus interface, the data rate for that bus connection can be used as the data transfer rate; other interface connections with other data rates can be used according to the particular hardware connections.

Illustrated processing block 274 provides for calculating a backend performance factor for the subgraph on the backend device—i.e., a potential performance for the subgraph if run on the backend device. In examples, the potential performance factor of the subgraph on the backend device can be computed as a compute_efficiency_index (CEI) as follows:

CEI=1/[SW_Efficiency*(FLOP_subgraph)/FLOPS_device+DTT)] EQ (1)

where SW_Efficiency is determined for the backend device (block 271), FLOP_subgraph is the number of floating point operations in the subgraph (block 272), DTT is the calculated data transfer time (block 273), and FLOPS_device is the maximum compute capacity of the backend device (in floating point operations per second)—which only needs to be determined once for the device.

Illustrated processing block 275 provides for calculating a default performance factor for the subgraph on the default runtime CPU—i.e., a potential performance for the subgraph if run on the default runtime CPU. In examples, the default performance factor of the subgraph on the default runtime CPU (denoted as DefPerf) can be computed as:

DefPerf=1/[FLOP_subgraph/FLOPS_CPU] EQ (2)

where FLOP subgraph is the number of floating point operations in the subgraph (block 272) and FLOPS_CPU is the maximum compute capacity of the default runtime CPU (in floating point operations per second)—which only needs to be determined once for the CPU.

Illustrated processing block 276 provides for selecting the subgraph to be run on the backend device when the backend performance factor for the subgraph (i.e., the potential performance of the subgraph on the backend device) exceeds the default performance factor for the subgraph (i.e., the potential performance of the subgraph on the default runtime CPU). In examples, the subgraph is selected to be run on the backend device when, for that subgraph:

CEI>DefPerf EQ (3)

where CEI (compute_efficiency_index) is the potential performance factor for the subgraph on the hardware backend device, as computed per EQ. (1), and DefPerf is the default performance factor for the subgraph on the default runtime CPU, as computed per EQ. (2).

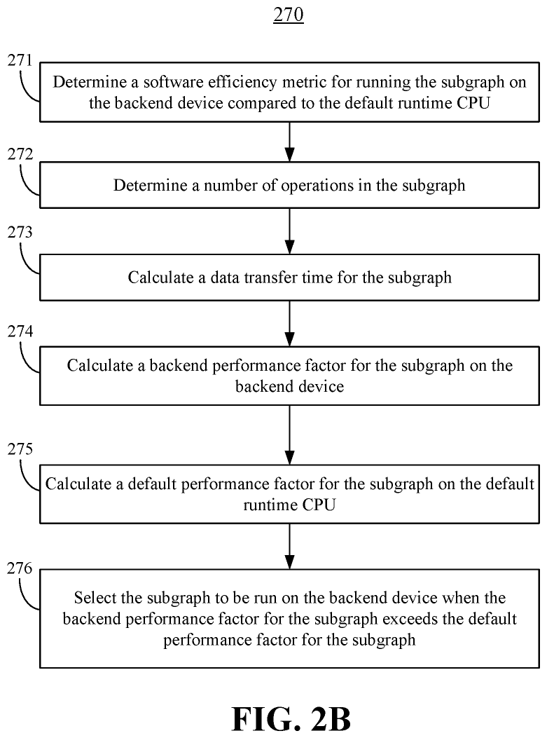

FIG. 3A provides a flow chart illustrating an example method 300 of operating an AI framework integration system according to one or more embodiments, with reference to components and features described herein including but not limited to the figures and associated description. The method 300 can generally be implemented in the system 100, such as, e.g., in the graph partitioner 120 (FIG. 1, already discussed). More particularly, the method 300 can be implemented as one or more modules in a set of logic instructions stored in a non-transitory machine- or computer-readable storage medium such as RAM, ROM, PROM, firmware, flash memory, etc., in configurable logic such as, for example, PLAs, FPGAs, CPLDs, in fixed-functionality hardware logic using circuit technology such as, for example, ASIC, CMOS or TTL technology, or any combination thereof.

For example, computer program code to carry out operations shown in the method 300 can be written in any combination of one or more programming languages, including an object oriented programming language such as JAVA, SMALLTALK, C++ or the like and conventional procedural programming languages, such as the “C” programming language or similar programming languages. Additionally, logic instructions might include assembler instructions, ISA instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 310 provides for generating a first set of subgraphs based on supported nodes of a model graph, wherein the supported nodes have operators that are supported by a hardware backend device separate from a default runtime. Illustrated processing block 320 provides for evaluating a compute efficiency of each subgraph of the first set of subgraphs relative to the hardware backend device and to a default CPU associated with the default runtime. Illustrated processing block 330 provides for selecting, from the first set of subgraphs, a second set of subgraphs to be run on the hardware backend device based on the evaluated compute efficiency.

FIG. 3B provides a flow chart illustrating an example method 340 for compute-based graph partitioning according to one or more embodiments, with reference to components and features described herein including but not limited to the figures and associated description. The method 340 can generally be implemented in the system 100 such as, e.g., in the graph partitioner 120 (FIG. 1, already discussed). All or portions of the method 340 can be substituted for all or a portion of illustrated processing block 320 and/or block 330 (FIG. 3A, already discussed). More particularly, the method 340 can be implemented as one or more modules in a set of logic instructions stored in a non-transitory machine- or computer-readable storage medium such as RAM, ROM, PROM, firmware, flash memory, etc., in configurable logic such as, for example, PLAs, FPGAs, CPLDs, in fixed-functionality hardware logic using circuit technology such as, for example, ASIC, CMOS or TTL technology, or any combination thereof.

For example, computer program code to carry out operations shown in the method 340 can be written in any combination of one or more programming languages, including an object oriented programming language such as JAVA, SMALLTALK, C++ or the like and conventional procedural programming languages, such as the “C” programming language or similar programming languages. Additionally, logic instructions might include assembler instructions, ISA instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 350 provides for calculating a backend performance factor for each subgraph for the hardware backend device. Illustrated processing block 360 provides for calculating a default performance factor for each subgraph for the default CPU. Illustrated processing block 370 provides for comparing, for each respective subgraph of the of the first set of subgraphs, the backend performance factor and the default performance factor, wherein the respective subgraph is selected for the second set of subgraphs when the backend performance factor is greater than the default performance factor.

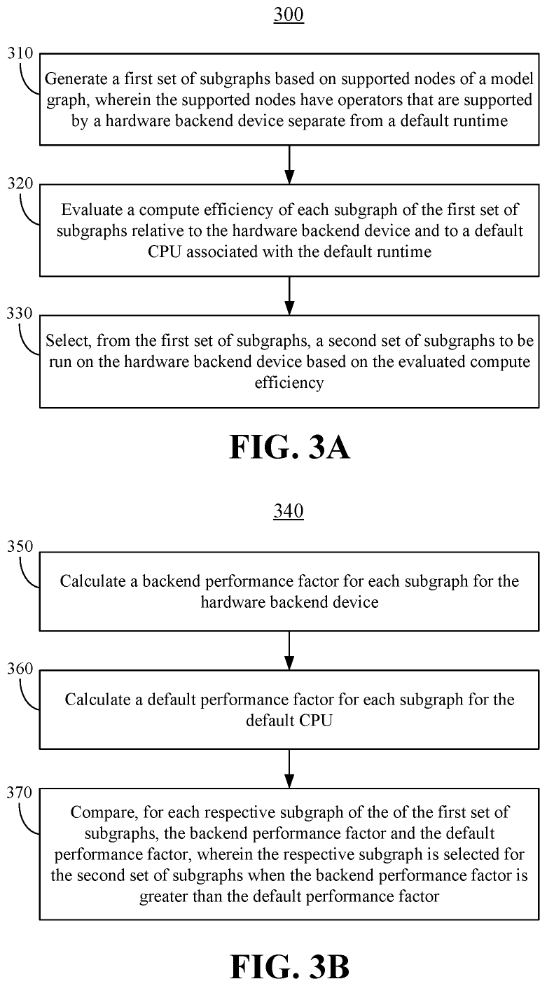

FIG. 4 shows a block diagram illustrating an example computing system 10 for AI framework integration according to one or more embodiments, with reference to components and features described herein including but not limited to the figures and associated description. The system 10 can generally be part of an electronic device/platform having computing and/or communications functionality (e.g., server, cloud infrastructure controller, database controller, notebook computer, desktop computer, personal digital assistant/PDA, tablet computer, convertible tablet, smart phone, etc.), imaging functionality (e.g., camera, camcorder), media playing functionality (e.g., smart television/TV), wearable functionality (e.g., watch, eyewear, headwear, footwear, jewelry), vehicular functionality (e.g., car, truck, motorcycle), robotic functionality (e.g., autonomous robot), Internet of Things (IoT) functionality, etc., or any combination thereof. In the illustrated example, the system 10 can include a host processor 12 (e.g., central processing unit/CPU) having an integrated memory controller (WIC) 14 that can be coupled to system memory 20. The host processor 12 can include any type of processing device, such as, e.g., microcontroller, microprocessor, RISC processor, ASIC, etc., along with associated processing modules or circuitry. The system memory 20 can include any non-transitory machine- or computer-readable storage medium such as RAM, ROM, PROM, EEPROM, firmware, flash memory, etc., configurable logic such as, for example, PLAs, FPGAs, CPLDs, fixed-functionality hardware logic using circuit technology such as, for example, ASIC, CMOS or TTL technology, or any combination thereof suitable for storing instructions 28.

The system 10 can also include an input/output (I/O) subsystem 16. The I/O subsystem 16 can communicate with for example, one or more input/output (I/O) devices 17, a network controller 24 (e.g., wired and/or wireless NIC), and storage 22. The storage 22 can be comprised of any appropriate non-transitory machine- or computer-readable memory type (e.g., flash memory, DRAM, SRAM (static random access memory), solid state drive (SSD), hard disk drive (HDD), optical disk, etc.). The storage 22 can include mass storage. In some embodiments, the host processor 12 and/ or the I/O subsystem 16 can communicate with the storage 22 (all or portions thereof) via a network controller 24. In some embodiments, the system 10 also includes a graphics processor 26 (e.g., a graphics processing unit/GPU) and an AI accelerator 27. In an embodiment, the system 10 can also include a vision processing unit (VPU), not shown.

The host processor 12 and the I/O subsystem 16 can be implemented together on a semiconductor die as a system on chip (SoC) 11, shown encased in a solid line. The SoC 11 can therefore operate as a computing apparatus for AI framework integration. In some embodiments, the SoC 11 can also include one or more of the system memory 20, the network controller 24, and/or the graphics processor 26 (shown encased in dotted lines). In some embodiments, the SoC 11 can also include other components of the system 10.

The host processor 12 and/or the I/O subsystem 16 can execute program instructions 28 retrieved from the system memory 20 and/or the storage 22 to perform one or more aspects of process 200, process 270, process 300, and/or process 340. The system 10 can implement one or more aspects of system 100 as described herein with reference to FIG. 1. The system 10 is therefore considered to be performance-enhanced at least to the extent that technology evaluates which subgraphs are, or are not, compute efficient to run on a backend by checking if the potential performance of the subgraph that can be achieved on the backend device is greater than the potential performance of the subgraph on the default runtime.

Computer program code to carry out the processes described above can be written in any combination of one or more programming languages, including an object-oriented programming language such as JAVA, JAVASCRIPT, PYTHON, SMALLTALK, C++ or the like and/or conventional procedural programming languages, such as the “C” programming language or similar programming languages, and implemented as program instructions 28. Additionally, program instructions 28 can include assembler instructions, ISA instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, microprocessor, etc.).

I/O devices 17 can include one or more of input devices, such as a touch-screen, keyboard, mouse, cursor-control device, touch-screen, microphone, digital camera, video recorder, camcorder, biometric scanners and/or sensors; input devices can be used to enter information and interact with system 10 and/or with other devices. The I/O devices 17 can also include one or more of output devices, such as a display (e.g., touch screen, liquid crystal display/LCD, light emitting diode/LED display, plasma panels, etc.), speakers and/or other visual or audio output devices. The input and/or output devices can be used, e.g., to provide a user interface.

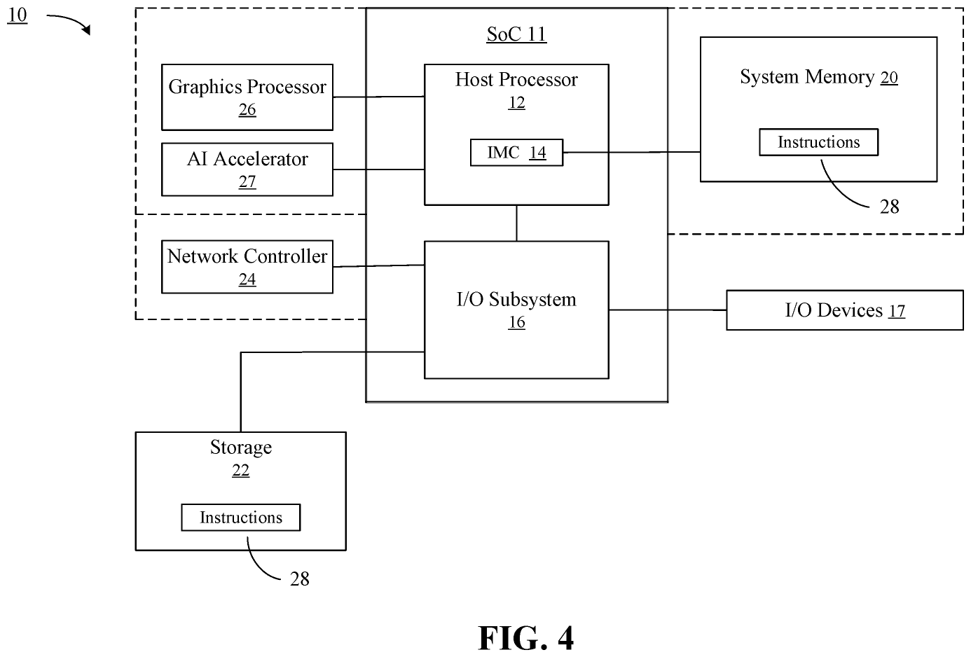

FIG. 5 shows a block diagram illustrating an example semiconductor apparatus 30 for AI framework integration according to one or more embodiments, with reference to components and features described herein including but not limited to the figures and associated description. The semiconductor apparatus 30 can be implemented, e.g., as a chip, die, or other semiconductor package. The semiconductor apparatus 30 can include one or more substrates 32 comprised of, e.g., silicon, sapphire, gallium arsenide, etc. The semiconductor apparatus 30 can also include logic 34 comprised of, e.g., transistor array(s) and other integrated circuit (IC) components) coupled to the substrate(s) 32. The logic 34 can be implemented at least partly in configurable logic or fixed-functionality logic hardware. The logic 34 can implement the system on chip (SoC) 11 described above with reference to FIG. 4. The logic 34 can implement one or more aspects of the processes described above, including process 200, process 270, process 300, and/or process 340. The logic 34 can implement one or more aspects of system 100 as described herein with reference to FIG. 1. The apparatus 30 is therefore considered to be performance-enhanced at least to the extent that the technology evaluates which subgraphs are, or are not, compute efficient to run on a backend by checking if the potential performance of the subgraph that can be achieved on the backend device is greater than the potential performance of the subgraph on the default runtime.

The semiconductor apparatus 30 can be constructed using any appropriate semiconductor manufacturing processes or techniques. For example, the logic 34 can include transistor channel regions that are positioned (e.g., embedded) within the substrate(s) 32. Thus, the interface between the logic 34 and the substrate(s) 32 can not be an abrupt junction. The logic 34 can also be considered to include an epitaxial layer that is grown on an initial wafer of the substrate(s) 34.

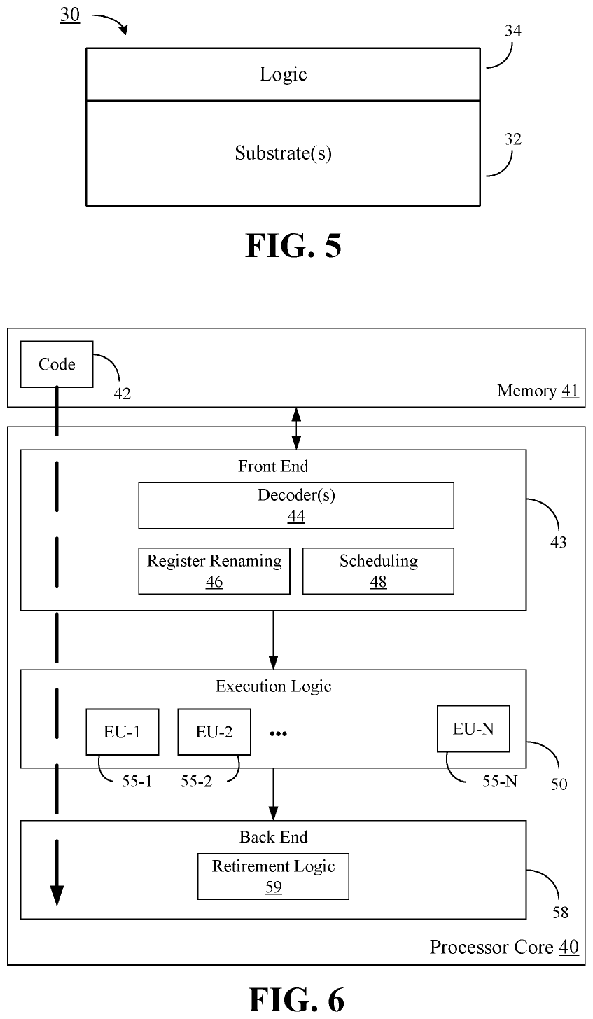

FIG. 6 is a block diagram illustrating an example processor core 40 according to one or more embodiments, with reference to components and features described herein including but not limited to the figures and associated description. The processor core 40 can be the core for any type of processor, such as a micro-processor, an embedded processor, a digital signal processor (DSP), a network processor, a GPU, or other device to execute code. Although only one processor core 40 is illustrated in FIG. 6, a processing element can alternatively include more than one of the processor core 40 illustrated in FIG. 6. The processor core 40 can be a single-threaded core or, for at least one embodiment, the processor core 40 can be multithreaded in that it can include more than one hardware thread context (or “logical processor”) per core.

FIG. 6 also illustrates a memory 41 coupled to the processor core 40. The memory 41 can be any of a wide variety of memories (including various layers of memory hierarchy) as are known or otherwise available to those of skill in the art. The memory 41 can include one or more code 42 instruction(s) to be executed by the processor core 40. The code 42 can implement one or more aspects of the processes described above, including process 200, process 270, process 300, and/or process 340. The processor core 40 can implement one or more aspects of system 100 as described herein with reference to FIG. 1. The processor core 40 can follow a program sequence of instructions indicated by the code 42. Each instruction can enter a front end portion 43 and be processed by one or more decoders 44. The decoder 44 can generate as its output a micro operation such as a fixed width micro operation in a predefined format, or can generate other instructions, microinstructions, or control signals which reflect the original code instruction. The illustrated front end portion 43 also includes register renaming logic 46 and scheduling logic 48, which generally allocate resources and queue the operation corresponding to the convert instruction for execution.

The processor core 40 is shown including execution logic 50 having a set of execution units 55-1 through 55-N. Some embodiments can include a number of execution units dedicated to specific functions or sets of functions. Other embodiments can include only one execution unit or one execution unit that can perform a particular function. The illustrated execution logic 50 performs the operations specified by code instructions.

After completion of execution of the operations specified by the code instructions, back end logic 58 retires the instructions of code 42. In one embodiment, the processor core 40 allows out of order execution but requires in order retirement of instructions. Retirement logic 59 can take a variety of forms as known to those of skill in the art (e.g., re-order buffers or the like). In this manner, the processor core 40 is transformed during execution of the code 42, at least in terms of the output generated by the decoder, the hardware registers and tables utilized by the register renaming logic 46, and any registers (not shown) modified by the execution logic 50.

Although not illustrated in FIG. 6, a processing element can include other elements on chip with the processor core 40. For example, a processing element can include memory control logic along with the processor core 40. The processing element can include I/O control logic and/or can include I/O control logic integrated with memory control logic. The processing element can also include one or more caches.

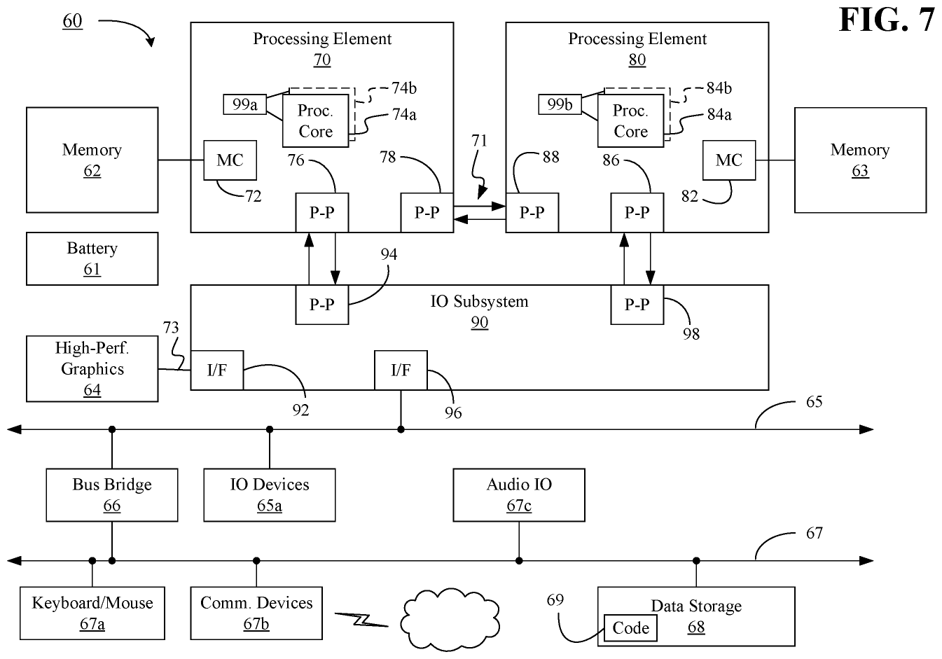

FIG. 7 is a block diagram illustrating an example of a multi-processor based computing system 60 according to one or more embodiments, with reference to components and features described herein including but not limited to the figures and associated description. The multiprocessor system 60 includes a first processing element 70 and a second processing element 80. While two processing elements 70 and 80 are shown, it is to be understood that an embodiment of the system 60 can also include only one such processing element.

The system 60 is illustrated as a point-to-point interconnect system, wherein the first processing element 70 and the second processing element 80 are coupled via a point-to-point interconnect 71. It should be understood that any or all of the interconnects illustrated in FIG. 7 can be implemented as a multi-drop bus rather than point-to-point interconnect.

As shown in FIG. 7, each of the processing elements 70 and 80 can be multicore processors, including first and second processor cores (i.e., processor cores 74a and 74b and processor cores 84a and 84b). Such cores 74a, 74b, 84a, 84b can be configured to execute instruction code in a manner similar to that discussed above in connection with FIG. 6.

Each processing element 70, 80 can include at least one shared cache 99a, 99b. The shared cache 99a, 99b can store data (e.g., instructions) that are utilized by one or more components of the processor, such as the cores 74a, 74b and 84a, 84b, respectively. For example, the shared cache 99a, 99b can locally cache data stored in a memory 62, 63 for faster access by components of the processor. In one or more embodiments, the shared cache 99a, 99b can include one or more mid-level caches, such as level 2 (L2), level 3 (L3), level 4 (L4), or other levels of cache, a last level cache (LLC), and/or combinations thereof.

While shown with only two processing elements 70, 80, it is to be understood that the scope of the embodiments is not so limited. In other embodiments, one or more additional processing elements can be present in a given processor. Alternatively, one or more of the processing elements 70, 80 can be an element other than a processor, such as an accelerator or a field programmable gate array. For example, additional processing element(s) can include additional processors(s) that are the same as a first processor 70, additional processor(s) that are heterogeneous or asymmetric to processor a first processor 70, accelerators (such as, e.g., graphics accelerators or digital signal processing (DSP) units), field programmable gate arrays, or any other processing element. There can be a variety of differences between the processing elements 70, 80 in terms of a spectrum of metrics of merit including architectural, micro architectural, thermal, power consumption characteristics, and the like. These differences can effectively manifest themselves as asymmetry and heterogeneity amongst the processing elements 70, 80. For at least one embodiment, the various processing elements 70, 80 can reside in the same die package.

The first processing element 70 can further include memory controller logic (MC) 72 and point-to-point (P-P) interfaces 76 and 78. Similarly, the second processing element 80 can include a MC 82 and P-P interfaces 86 and 88. As shown in FIG. 7, MC's 72 and 82 couple the processors to respective memories, namely a memory 62 and a memory 63, which can be portions of main memory locally attached to the respective processors. While the MC 72 and 82 is illustrated as integrated into the processing elements 70, 80, for alternative embodiments the MC logic can be discrete logic outside the processing elements 70, 80 rather than integrated therein.

The first processing element 70 and the second processing element 80 can be coupled to an I/O subsystem 90 via P-P interconnects 76 and 86, respectively. As shown in FIG. 7, the I/O subsystem 90 includes P-P interfaces 94 and 98. Furthermore, the I/O subsystem 90 includes an interface 92 to couple I/O subsystem 90 with a high performance graphics engine 64. In one embodiment, a bus 73 can be used to couple the graphics engine 64 to the I/O subsystem 90. Alternately, a point-to-point interconnect can couple these components.

In turn, the I/O subsystem 90 can be coupled to a first bus 65 via an interface 96. In one embodiment, the first bus 65 can be a Peripheral Component Interconnect (PCI) bus, or a bus such as a PCI Express bus or another third generation I/O interconnect bus, although the scope of the embodiments are not so limited.

As shown in FIG. 7, various I/O devices 65a (e.g., biometric scanners, speakers, cameras, and/or sensors) can be coupled to the first bus 65, along with a bus bridge 66 which can couple the first bus 65 to a second bus 67. In one embodiment, the second bus 67 can be a low pin count (LPC) bus. Various devices can be coupled to the second bus 67 including, for example, a keyboard/mouse 67a, communication device(s) 67b, and a data storage unit 68 such as a disk drive or other mass storage device which can include code 69, in one embodiment. The illustrated code 69 can implement one or more aspects of the processes described above, including process 200, process 270, process 300, and/or process 340. The illustrated code 69 can be similar to the code 42 (FIG. 6), already discussed. Further, an audio I/O 67c can be coupled to second bus 67 and a battery 61 can supply power to the computing system 60. The system 60 can implement one or more aspects of system 100 as described herein with reference to FIG. 1.

Note that other embodiments are contemplated. For example, instead of the point-to-point architecture of FIG. 7, a system can implement a multi-drop bus or another such communication topology. Also, the elements of FIG. 7 can alternatively be partitioned using more or fewer integrated chips than shown in FIG. 7.

Embodiments of each of the above systems, devices, components and/or methods, including the system 10, the semiconductor apparatus 30, the processor core 40, the system 60, system 100, process 200, process 270, process 300, process 340, and/or any other system components, can be implemented in hardware, software, or any suitable combination thereof. For example, hardware implementations can include configurable logic such as, for example, PLAs, FPGAs, CPLDs, or fixed-functionality logic hardware using circuit technology such as, for example, ASIC, CMOS or TTL technology, or any combination thereof

Alternatively, or additionally, all or portions of the foregoing systems and/or components and/or methods can be implemented in one or more modules as a set of logic instructions stored in a machine- or computer-readable storage medium such as RAM, ROM, PROM, firmware, flash memory, etc., to be executed by a processor or computing device. For example, computer program code to carry out the operations of the components can be written in any combination of one or more operating system (OS) applicable/appropriate programming languages, including an object-oriented programming language such as PYTHON, PERL, JAVA, SMALLTALK, C++, C# or the like and conventional procedural programming languages, such as the “C” programming language or similar programming languages.

### ADDITIONAL NOTES AND EXAMPLES

Example 1 includes a computing system, comprising a processor, and a memory coupled to the processor to store instructions which, when executed by the processor, cause the processor to generate a first set of subgraphs based on supported nodes of a model graph, wherein the supported nodes have operators that are supported by a hardware backend device separate from a default runtime, evaluate a compute efficiency of each subgraph of the first set of subgraphs with respect to the hardware backend device and to a default central processing unit (CPU) associated with the default runtime, and select, from the first set of subgraphs, a second set of subgraphs to be run on the hardware backend device based on the evaluated compute efficiency.

Example 2 includes the system of Example 1, wherein to evaluate the compute efficiency of each subgraph comprises to calculate a backend performance factor for each subgraph for the hardware backend device.

Example 3 includes the system of Example 2, wherein to evaluate the compute efficiency of each subgraph further comprises to calculate a default performance factor for each subgraph for the default CPU.

Example 4 includes the system of Example 3, wherein the backend performance factor is based on at least one of a number of operations in the respective subgraph, a data transfer time for the respective subgraph, or a maximum compute capacity of the hardware backend device, and wherein the default performance factor is based on at least one of the number of operations in the respective subgraph or a maximum compute capacity of the CPU associated with the default runtime.

Example 5 includes the system of Example 3, wherein the instructions, when executed by the processor, further cause the processor to compare, for each respective subgraph of the of the first set of subgraphs, the backend performance factor and the default performance factor, wherein the respective subgraph is selected for the second set of subgraphs when the backend performance factor is greater than the default performance factor.

Example 6 includes the system of any one of Examples 1-5, wherein the instructions, when executed by the processor, further cause the processor to select a remaining set of nodes to be run on the default runtime, wherein the remaining set of nodes includes unsupported nodes of the model graph and nodes corresponding to each respective subgraph when the backend performance factor is less than the default performance factor, and wherein each of the unsupported nodes has an operator that is unsupported by the hardware backend device.

Example 7 includes a semiconductor apparatus comprising one or more substrates, and logic coupled to the one or more substrates, wherein the logic is implemented at least partly in one or more of configurable logic or fixed-functionality hardware logic, the logic coupled to the one or more substrates to generate a first set of subgraphs based on supported nodes of a model graph, wherein the supported nodes have operators that are supported by a hardware backend device separate from a default runtime, evaluate a compute efficiency of each subgraph of the first set of subgraphs with respect to the hardware backend device and to a default central processing unit (CPU) associated with the default runtime, and select, from the first set of subgraphs, a second set of subgraphs to be run on the hardware backend device based on the evaluated compute efficiency.

Example 8 includes the apparatus of Example 7, wherein to evaluate the compute efficiency of each subgraph comprises to calculate a backend performance factor for each subgraph for the hardware backend device.

Example 9 includes the apparatus of Example 8, wherein to evaluate the compute efficiency of each subgraph further comprises to calculate a default performance factor for each subgraph for the default CPU.

Example 10 includes the apparatus of Example 9, wherein the backend performance factor is based on at least one of a number of operations in the respective subgraph, a data transfer time for the respective subgraph, or a maximum compute capacity of the hardware backend device, and wherein the default performance factor is based on at least one of the number of operations in the respective subgraph or a maximum compute capacity of the CPU associated with the default runtime.

Example 11 includes the apparatus of Example 9, wherein the logic coupled to the one or more substrates is further to compare, for each respective subgraph of the of the first set of subgraphs, the backend performance factor and the default performance factor, wherein the respective subgraph is selected for the second set of subgraphs when the backend performance factor is greater than the default performance factor.

Example 12 includes the apparatus of any one of Examples 7-11, wherein the logic coupled to the one or more substrates is further to select a remaining set of nodes to be run on the default runtime, wherein the remaining set of nodes includes unsupported nodes of the model graph and nodes corresponding to each respective subgraph when the backend performance factor is less than the default performance factor, and wherein each of the unsupported nodes has an operator that is unsupported by the hardware backend device.

Example 13 includes the apparatus of Example 7, wherein the logic coupled to the one or more substrates includes transistor channel regions that are positioned within the one or more substrates.

Example 14 includes at least one non-transitory computer readable storage medium comprising a set of instructions which, when executed by a computing system, cause the computing system to generate a first set of subgraphs based on supported nodes of a model graph, wherein the supported nodes have operators that are supported by a hardware backend device separate from a default runtime, evaluate a compute efficiency of each subgraph of the first set of subgraphs with respect to the hardware backend device and to a default central processing unit (CPU) associated with the default runtime, and select, from the first set of subgraphs, a second set of subgraphs to be run on the hardware backend device based on the evaluated compute efficiency.

Example 15 includes the at least one non-transitory computer readable storage medium of Example 14, wherein to evaluate the compute efficiency of each subgraph comprises to calculate a backend performance factor for each subgraph for the hardware backend device.

Example 16 includes the at least one non-transitory computer readable storage medium of Example 15, wherein to evaluate the compute efficiency of each subgraph further comprises to calculate a default performance factor for each subgraph for the default CPU.

Example 17 includes the at least one non-transitory computer readable storage medium of Example 16, wherein the backend performance factor is based on at least one of a number of operations in the respective subgraph, a data transfer time for the respective subgraph, or a maximum compute capacity of the hardware backend device, and wherein the default performance factor is based on at least one of the number of operations in the respective subgraph or a maximum compute capacity of the CPU associated with the default runtime.

Example 18 includes the at least one non-transitory computer readable storage medium of Example 16, wherein the instructions, when executed by the computing system, further cause the computing system to compare, for each respective subgraph of the of the first set of subgraphs, the backend performance factor and the default performance factor, wherein the respective subgraph is selected for the second set of subgraphs when the backend performance factor is greater than the default performance factor.

Example 19 includes the at least one non-transitory computer readable storage medium of any one of Examples 14-18, wherein the instructions, when executed by the computing system, further cause the computing system to select a remaining set of nodes to be run on the default runtime, wherein the remaining set of nodes includes unsupported nodes of the model graph and nodes corresponding to each respective subgraph when the backend performance factor is less than the default performance factor, and wherein each of the unsupported nodes has an operator that is unsupported by the hardware backend device.

Example 20 includes a method comprising generating a first set of subgraphs based on supported nodes of a model graph, wherein the supported nodes have operators that are supported by a hardware backend device separate from a default runtime, evaluating a compute efficiency of each subgraph of the first set of subgraphs with respect to the hardware backend device and to a default central processing unit (CPU) associated with the default runtime, and selecting, from the first set of subgraphs, a second set of subgraphs to be run on the hardware backend device based on the evaluated compute efficiency.

Example 21 includes the method of Example 20, wherein evaluating the compute efficiency of each subgraph comprises calculating a backend performance factor for each subgraph for the hardware backend device.

Example 22 includes the method of Example 21, wherein evaluating the compute efficiency of each subgraph further comprises calculating a default performance factor for each subgraph for the default CPU.

Example 23 includes the method of Example 22, wherein the backend performance factor is based on at least one of a number of operations in the respective subgraph, a data transfer time for the respective subgraph, or a maximum compute capacity of the hardware backend device, and wherein the default performance factor is based on at least one of the number of operations in the respective subgraph or a maximum compute capacity of the CPU associated with the default runtime.

Example 24 includes the method of Example 22, further comprising comparing, for each respective subgraph of the of the first set of subgraphs, the backend performance factor and the default performance factor, wherein the respective subgraph is selected for the second set of subgraphs when the backend performance factor is greater than the default performance factor.

Example 25 includes the method of any one of Examples 20-24, further comprising selecting a remaining set of nodes to be run on the default runtime, wherein the remaining set of nodes includes unsupported nodes of the model graph and nodes corresponding to each respective subgraph when the backend performance factor is less than the default performance factor, and wherein each of the unsupported nodes has an operator that is unsupported by the hardware backend device.

Example 26 includes an apparatus comprising means for performing the method of any one of Examples 20-24.

Embodiments are applicable for use with all types of semiconductor integrated circuit (“IC”) chips. Examples of these IC chips include but are not limited to processors, controllers, chipset components, PLAs, memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections, including logical connections via intermediate components (e.g., device A may be coupled to device C via device B). In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A, B, C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A computing system, comprising:
a processor; and
a memory coupled to the processor to store instructions which, when executed by the processor, cause the processor to:
generate a first set of subgraphs based on supported nodes of a model graph, wherein the supported nodes have operators that are supported by a hardware backend device separate from a default runtime;
evaluate a compute efficiency of each subgraph of the first set of subgraphs with respect to the hardware backend device and to a default central processing unit (CPU) associated with the default runtime; and
select, from the first set of subgraphs, a second set of subgraphs to be run on the hardware backend device based on the evaluated compute efficiency.

2. The system of claim 1, wherein to evaluate the compute efficiency of each subgraph comprises to calculate a backend performance factor for each subgraph for the hardware backend device.

3. The system of claim 2, wherein to evaluate the compute efficiency of each subgraph further comprises to calculate a default performance factor for each subgraph for the default CPU.

4. The system of claim 3, wherein the backend performance factor is based on at least one of a number of operations in the respective subgraph, a data transfer time for the respective subgraph, or a maximum compute capacity of the hardware backend device, and wherein the default performance factor is based on at least one of the number of operations in the respective subgraph or a maximum compute capacity of the CPU associated with the default runtime.

5. The system of claim 3, wherein the instructions, when executed by the processor, further cause the processor to compare, for each respective subgraph of the of the first set of subgraphs, the backend performance factor and the default performance factor, wherein the respective subgraph is selected for the second set of subgraphs when the backend performance factor is greater than the default performance factor.

6. The system of claim 5, wherein the instructions, when executed by the processor, further cause the processor to select a remaining set of nodes to be run on the default runtime, wherein the remaining set of nodes includes unsupported nodes of the model graph and nodes corresponding to each respective subgraph when the backend performance factor is less than the default performance factor, and wherein each of the unsupported nodes has an operator that is unsupported by the hardware backend device.

7. A semiconductor apparatus comprising:
one or more substrates; and
logic coupled to the one or more substrates, wherein the logic is implemented at least partly in one or more of configurable logic or fixed-functionality hardware logic, the logic coupled to the one or more substrates to:
generate a first set of subgraphs based on supported nodes of a model graph, wherein the supported nodes have operators that are supported by a hardware backend device separate from a default runtime;
evaluate a compute efficiency of each subgraph of the first set of subgraphs with respect to the hardware backend device and to a default central processing unit (CPU) associated with the default runtime; and
select, from the first set of subgraphs, a second set of subgraphs to be run on the hardware backend device based on the evaluated compute efficiency.

8. The apparatus of claim 7, wherein to evaluate the compute efficiency of each subgraph comprises to calculate a backend performance factor for each subgraph for the hardware backend device.

9. The apparatus of claim 8, wherein to evaluate the compute efficiency of each subgraph further comprises to calculate a default performance factor for each subgraph for the default CPU.

10. The apparatus of claim 9, wherein the backend performance factor is based on at least one of a number of operations in the respective subgraph, a data transfer time for the respective subgraph, or a maximum compute capacity of the hardware backend device, and wherein the default performance factor is based on at least one of the number of operations in the respective subgraph or a maximum compute capacity of the CPU associated with the default runtime.

11. The apparatus of claim 9, wherein the logic coupled to the one or more substrates is further to compare, for each respective subgraph of the of the first set of subgraphs, the backend performance factor and the default performance factor, wherein the respective subgraph is selected for the second set of subgraphs when the backend performance factor is greater than the default performance factor.

12. The apparatus of claim 11, wherein the logic coupled to the one or more substrates is further to select a remaining set of nodes to be run on the default runtime, wherein the remaining set of nodes includes unsupported nodes of the model graph and nodes corresponding to each respective subgraph when the backend performance factor is less than the default performance factor, and wherein each of the unsupported nodes has an operator that is unsupported by the hardware backend device.

13. The apparatus of claim 7, wherein the logic coupled to the one or more substrates includes transistor channel regions that are positioned within the one or more substrates.

14. At least one non-transitory computer readable storage medium comprising a set of instructions which, when executed by a computing system, cause the computing system to:
generate a first set of subgraphs based on supported nodes of a model graph, wherein the supported nodes have operators that are supported by a hardware backend device separate from a default runtime;
evaluate a compute efficiency of each subgraph of the first set of subgraphs with respect to the hardware backend device and to a default central processing unit (CPU) associated with the default runtime; and
select, from the first set of subgraphs, a second set of subgraphs to be run on the hardware backend device based on the evaluated compute efficiency.

15. The at least one non-transitory computer readable storage medium of claim 14, wherein to evaluate the compute efficiency of each subgraph comprises to calculate a backend performance factor for each subgraph for the hardware backend device.

16. The at least one non-transitory computer readable storage medium of claim 15, wherein to evaluate the compute efficiency of each subgraph further comprises to calculate a default performance factor for each subgraph for the default CPU.

17. The at least one non-transitory computer readable storage medium of claim 16, wherein the backend performance factor is based on at least one of a number of operations in the respective subgraph, a data transfer time for the respective subgraph, or a maximum compute capacity of the hardware backend device, and wherein the default performance factor is based on at least one of the number of operations in the respective subgraph or a maximum compute capacity of the CPU associated with the default runtime.

18. The at least one non-transitory computer readable storage medium of claim 16, wherein the instructions, when executed by the computing system, further cause the computing system to compare, for each respective subgraph of the of the first set of subgraphs, the backend performance factor and the default performance factor, wherein the respective subgraph is selected for the second set of subgraphs when the backend performance factor is greater than the default performance factor.

19. The at least one non-transitory computer readable storage medium of claim 18, wherein the instructions, when executed by the computing system, further cause the computing system to select a remaining set of nodes to be run on the default runtime, wherein the remaining set of nodes includes unsupported nodes of the model graph and nodes corresponding to each respective subgraph when the backend performance factor is less than the default performance factor, and wherein each of the unsupported nodes has an operator that is unsupported by the hardware backend device.

20. A method comprising:
generating a first set of subgraphs based on supported nodes of a model graph, wherein the supported nodes have operators that are supported by a hardware backend device separate from a default runtime;
evaluating a compute efficiency of each subgraph of the first set of subgraphs with respect to the hardware backend device and to a default central processing unit (CPU) associated with the default runtime; and
selecting, from the first set of subgraphs, a second set of subgraphs to be run on the hardware backend device based on the evaluated compute efficiency.

21. The method of claim 20, wherein evaluating the compute efficiency of each subgraph comprises calculating a backend performance factor for each subgraph for the hardware backend device.

22. The method of claim 21, wherein evaluating the compute efficiency of each subgraph further comprises calculating a default performance factor for each subgraph for the default CPU.

23. The method of claim 22, wherein the backend performance factor is based on at least one of a number of operations in the respective subgraph, a data transfer time for the respective subgraph, or a maximum compute capacity of the hardware backend device, and wherein the default performance factor is based on at least one of the number of operations in the respective subgraph or a maximum compute capacity of the CPU associated with the default runtime.

24. The method of claim 22, further comprising comparing, for each respective subgraph of the of the first set of subgraphs, the backend performance factor and the default performance factor, wherein the respective subgraph is selected for the second set of subgraphs when the backend performance factor is greater than the default performance factor.

25. The method of claim 24, further comprising selecting a remaining set of nodes to be run on the default runtime, wherein the remaining set of nodes includes unsupported nodes of the model graph and nodes corresponding to each respective subgraph when the backend performance factor is less than the default performance factor, and wherein each of the unsupported nodes has an operator that is unsupported by the hardware backend device.
